(19) United States
(12) Patent Application Publication
(10) Pub. No.: US 2026/0219985 A1
(43) Pub. Date: Jul. 30, 2026

(54) ERROR CHECKING FOR MACHINE LEARNING HARDWARE ACCELERATORS

(71) Applicant: GDM Holding LLC, Mountain View, CA (US)

(72) Inventors: Paul Ronald Barham, San Francisco, CA (US); James Molloy, Mountain View, CA (US); Sayed Hadi HashemI, Sunnyvale, CA (US); Denys Vnukov, Foster City, CA (US)

(21) Appl. No.: 19/039,665

(22) Filed: Jan. 28, 2025

(51) Int. Cl. G06F 11/10; G06F 11/14; G06F 11/34

(52) U.S. Cl. CPC G06F 11/1004; G06F 11/1476; G06F 11/3409; G06F 2201/835

(57) ABSTRACT

Methods, systems, and apparatus, including computer programs encoded on a computer storage medium, for detecting silent data corruptions (SDCs) or other errors induced by hardware faults that occur in hardware devices. One of the methods include receiving data representing a machine learning training workload for training a neural network; and executing the machine learning training workload across the plurality of hardware devices, the executing comprising, at each of at least a subset of the plurality of hardware devices, repeatedly performing training operations comprising: performing one or more computation operations to generate local output data at a corresponding time point; generating, based at least on the local output data, a first checksum for the corresponding time point for detecting errors induced by hardware faults; storing the first checksum in a memory; and transmitting the local output data from the hardware device to another hardware device over a network.

### BACKGROUND

This specification relates to executing machine learning workloads on hardware devices. The machine learning workloads can include workloads for training machine learning models, including neural networks. The hardware devices can include hardware accelerators.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of network parameters.

Hardware accelerators (or “accelerators” for short) are computing devices having specialized hardware configured to perform specialized computations including, e.g., machine learning computations. Examples of accelerators include graphics processing units (“GPUs”), field-programmable gate arrays (“FGPAs”), and application-specific integrated circuits (“ASICs”), including tensor processing units (“TPUs”).

Silent data corruptions (SDCs), sometimes referred to as silent data errors (SDEs), have increased as hardware accelerators have evolved. SDCs may be a result of technology node shrink, less reliable transistors, reduction in design margin and guard bands. SDCs may also be a result of insufficient burn-in testing, exponential increase in the number of transistors, etc. An SDC occurs when an impacted hardware accelerator inadvertently causes errors in the data it processes. The SDC can contribute to data loss and corruption and can thus jeopardize the training of the machine learning models.

### SUMMARY

This specification describes techniques for detecting silent data corruptions (SDCs) or other errors induced by hardware faults that occur in hardware devices and mitigating the negative impacts of such errors on machine learning workloads that are being executed on the hardware devices.

According to an aspect, there is provided a method performed by a plurality of hardware devices, the method comprising: receiving data representing a machine learning training workload for training a neural network; and executing the machine learning training workload across the plurality of hardware devices, the executing comprising, at each of at least a subset of the plurality of hardware devices, repeatedly performing training operations comprising: performing one or more computation operations to generate local output data at a corresponding time point; generating, based at least on the local output data, a first checksum for the corresponding time point for detecting errors induced by hardware faults; storing the first checksum in a storage device; and transmitting the local output data from the hardware device to another hardware device over a network.

The method may further comprise: obtaining an indication of an occurrence of an error during the executing of the machine learning workload across the plurality of hardware devices; response, for each of at least the subset of the plurality of hardware devices and for each of one or more preceding time points that precede the occurrence of the error: replaying one or more computation operations performed at the preceding time point to generate replayed local output data for the preceding time point; generating, based at least on the replayed local output data, a second checksum for the preceding time point; obtaining a first checksum for the preceding time point from the storage device; and comparing the first checksum with the second checksum to generate a comparison result that indicates whether a mismatch between the first checksum and the second checksum exists for the hardware device for the preceding time point; and identifying, based on the comparison result generated for each of at least the subset of the plurality of hardware devices and for each of one or more preceding time points, a faulty hardware device among the plurality of hardware devices that caused the error.

Identifying the faulty hardware device among the plurality of hardware devices that caused the error may comprise: determining an earliest time point in the one or more preceding time points at which a mismatch exists; and selecting, as the faulty hardware device that caused the error, a hardware device that has the mismatch at the earliest time point.

The hardware device may be a hardware accelerator. Replaying the one or more computation operations performed at the preceding time point may comprise: using a different compute core of the hardware accelerator to perform the one or more computation operations.

Obtaining the indication of the occurrence of the error during the executing of the machine learning training workload may comprise: monitoring a performance of the neural network during the training; and in response to determining that the performance of the neural network has degraded by greater than a threshold amount, generating the indication of the occurrence of the error.

The method may further comprise: resuming executing the machine learning training workload without using the faulty hardware device.

The storage device may comprise a high bandwidth memory local to the hardware accelerator.

The storage device may comprise a memory of a host computer.

According to another aspect, there is provided a system comprising one or more computers and one or more storage devices storing instructions that are operable, when executed by the one or more computers, to cause the one or more computers to perform the operations of the above method aspect.

According to a further aspect, there is provided a computer storage medium encoded with instructions that, when executed by one or more computers, cause the one or more computers to perform the operations of the method aspect.

It will be appreciated that features described in the context of one aspect may be combined with features described in the context of another aspect.

Particular embodiments of the subject matter described in this specification can be implemented so as to realize one or more of the following advantages.

An SDC can contribute to data loss and corruption. When there are a large number of hardware devices, an SDC caused by a single faulty hardware device may quickly propagate among other hardware devices and severely impact the quality, e.g., accuracy, of the workload that is being executed on the hardware devices. Further, the originating hardware device that caused the SDC can be difficult to identify from among the large number of hardware devices by using conventional error detection techniques.

The described checksum matching techniques, on the other hand, allow for a silent data corruption (SDC) or another error induced by a hardware fault of a hardware device to be detected and localized rapidly, and further allow for remedial actions to be promptly taken to mitigate the negative impacts of the error on a workload having at least a portion of it being executed on the hardware device.

The described checksum matching techniques can facilitate error detection without negatively affecting the performance of the hardware devices. Advantageously, the described techniques improve the efficiency of error detection over existing error detection techniques by generating a minimally needed number of checksums during the execution of the workload that can later be compared with checksums generated for replayed computation operations for error detection.

A system implementing the described techniques need only generate and store a checksum for each hardware device prior to each data exchange operation during workload execution. In doing so, the system avoids needing to generate and store a checksum for every computation operation during the workload execution; the system further avoids needing to replay every computation operation during the workload execution.

The rapid identification of which hardware device introduced the errors as enabled by the described techniques can be particularly important when the hardware device is part of a large number of hardware devices performing a large-scale machine learning training workload to train a large-scale neural network that has many parameters. In effect, the described checksum matching techniques can improve the manageability, stability, or both of training process of the large-scale neural network by minimizing the negative impacts of SDCs and can reduce the amount of computing and energy resources that would be consumed by existing neural network training systems to identify and recover from the SDCs. In another aspect, the described checksum matching techniques can improve the overall performance of hardware devices, e.g., in terms of the accuracy of computation operations that are being executed thereon.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example system for executing a machine learning workload.

FIG. 2 shows an example architecture of a hardware accelerator.

FIG. 3 is an illustration of operations to mitigate silent data corruption (SDC) when executing a machine learning training workload.

FIG. 4 is a flow diagram of an example process for executing a machine learning training workload.

FIG. 5 is a flow diagram of an example process for identifying a faulty hardware device.

Like reference numbers and designations in the various drawings indicate like elements.

### DETAILED DESCRIPTION

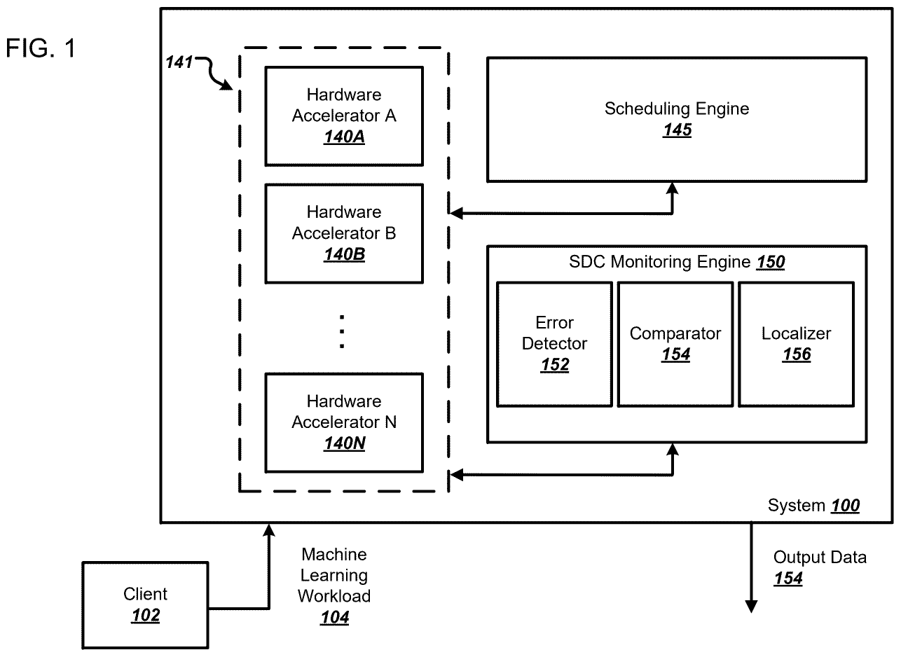

FIG. 1 illustrates an example system 100 for executing a machine learning workload 104. The machine learning workload 104 can be specified by a client 102. The system 100 can receive data specifying the machine learning workload 104 from the client 102, and generate output data 154 as a result of the execution of the machine learning workload 104.

The machine learning workload 104 can include computation operations for training a neural network having a plurality of parameters, i.e., to update the values of the parameters.

As part of executing the machine learning workload 104, the system 100 performs the training over a plurality of training steps. At each training step, the system 100 updates the parameters of the neural network using a plurality of training examples (a “batch” or a “mini-batch” of training examples) sampled from training data.

More specifically, at each iteration, the system 100 determines the parameter value update based on computing, using the plurality of training examples, a current gradient of an objective function with respect to each of at least some of the parameters of the neural network.

By performing the plurality of training steps, the system 100 repeatedly updates the values of the parameters of the neural network to determine updated values that will cause the neural network to perform well on one or more machine learning task(s).

As a result of the training, the neural network can be configured to perform a machine learning task by processing a network input in accordance with the parameters to generate one or more network outputs for the machine learning task.

Some examples of machine learning tasks that the neural network can be configured through training to perform will now be discussed.

In some cases, the neural network is a neural network that is configured to perform an image processing task, i.e., receive an input image and to process the input image to generate a network output for the input image. As another example, the task can be image embedding generation and the output generated by the neural network can be a numeric embedding of the input image. As yet another example, the task can be object detection and the output generated by the neural network can identify locations in the input image at which particular types of objects are depicted. As yet another example, the task can be image segmentation and the output generated by the neural network can assign each pixel of the input image to a category from a set of categories. In some other cases, the neural network is a neural network that is configured to perform an image generation task, where the input is a conditioning input and the output is a sequence of intensity value inputs for the pixels of an image. In an analogous example, the neural network can be a neural network that is configured to perform a video generation task to generate a video that includes a plurality of frames where each frame is an image.

As one example, the task may be a neural machine translation task. For example, if the input to the neural network is a sequence of text, e.g., a sequence of words, phrases, characters, or word pieces, in one language, the output generated by the neural network may be a translation of the sequence of text into another language, i.e., a sequence of text in the other language that is a translation of the input sequence of text. The vocabulary for the input tokens may be words, wordpieces or characters of the first language, and the vocabulary for the output tokens may be words, wordpieces or characters of the other language. As a particular example, the task may be a multi-lingual machine translation task, where a single neural network is configured to translate between multiple different source language - target language pairs. In this example, the source language text may be augmented with an identifier that indicates the target language into which the neural network should translate the source language text.

Some implementations may be used for automatic code generation. For example the input tokens may represent words, wordpieces or characters in a first natural language and the output tokens may represent instructions in a computer programming or markup language, or instructions for controlling an application program to perform a task e.g. build a data item such as an image or web page.

As another example, the task may be an audio processing task. For example, if the input to the neural network is a sequence representing a spoken utterance, the output generated by the neural network may be a score for each of a set of pieces of text, each score representing an estimated likelihood that the piece of text is the correct transcript for the utterance. As another example, if the input to the neural network is a sequence representing a spoken utterance, the output generated by the neural network can indicate whether a particular word or phrase (“hotword”) was spoken in the utterance. As another example, if the input to the neural network is a sequence representing a spoken utterance, the output generated by the neural network can be a classification of the spoken utterance into one of a plurality of categories, for example an identity of the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input is text in a natural language or features of text in a natural language and the network output is a spectrogram, a waveform, or other data defining audio of the text being spoken in the natural language.

As another example, the task can be a health prediction task, where the input is a sequence derived from electronic health record data for a patient and the output is a prediction that is relevant to the future health of the patient, e.g., a predicted treatment that should be prescribed to the patient, the likelihood that an adverse health event will occur to the patient, or a predicted diagnosis for the patient. Such electronic health data may, for example, comprise one or more sequences of physiological data taken from a patient, with the output being a corresponding prediction that relates to those sequences of data. Examples of physiological data and a corresponding prediction include: blood glucose measurements, with the prediction being a predicted future blood glucose measurement or the prediction of a hyper-or hypo-glycemic event; a heart rate, with the prediction being the presence or absence of a heart condition, or a future cardiac event; blood pressure measurements, with the prediction being the risk of a future heart condition; or the like.

As another example, the task can be a text generation task, where the input is a sequence of text, and the output is another sequence of text, e.g., a completion of the input sequence of text, a response to a question posed in the input sequence, or a sequence of text that is about a topic specified by the first sequence of text. As another example, the input to the text generation task can be an input other than text, e.g., an image, and the output sequence can be text that describes the input.

In some implementations the input sequence represents data to be compressed, e.g. image data, text data, audio data, or any other type of data; and the output sequence a compressed version of the data. The input and output tokens may each comprise any representation of the data to be compressed/compressed data e.g. symbols or embeddings generated/decoded by a respective neural network.

As another example, the task can be an agent control task, where the input is a sequence of observations or other data characterizing states of an environment and the output defines an action to be performed by the agent in response to the most recent data in the sequence. The agent can be, e.g., a real-world or simulated robot, a control system for an industrial facility, or a control system that controls a different kind of agent. The observations may comprise sensor data captured by sensors associated with (e.g. part of) the agent, for example visual data, LIDAR data, sonar data, agent configuration data (e.g. joint angles), agent orientation data, or the like.

In some implementations, the environment is a real-world environment, the agent is a mechanical (or electro-mechanical) agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot interacting with the environment to accomplish a specific task, e.g., to locate or manipulate an object of interest in the environment or to move an object of interest to a specified location in the environment or to navigate to a specified destination in the environment.

In these implementations, the observations may include, e.g., one or more of: images, object position data, and sensor data to capture observations as the agent interacts with the environment, for example sensor data from an image, distance, or position sensor or from an actuator. For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example captured by a camera or a LIDAR sensor, e.g., data from sensors of the agent or data from sensors that are located separately from the agent in the environment.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements e.g. steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the control signals may define actions to control navigation e.g. steering, and movement e.g., braking and/or acceleration of the vehicle.

In some implementations the environment is a simulation of the above-described real-world environment, and the agent is implemented as one or more computers interacting with the simulated environment. For example, a system implementing the neural network may be used to select actions in the simulated environment during training or evaluation of the system and, after training, or evaluation, or both, are complete, the action selection policy may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example the system may be partly trained using a simulation of a mechanical agent in a simulation of a particular real-world environment, and afterwards deployed to control the real mechanical agent in the particular real-world environment. Thus in such cases the observations of the simulated environment relate to the real-world environment, and the selected actions in the simulated environment relate to actions to be performed by the mechanical agent in the real-world environment.

In some implementations, as described above, the agent may not include a human being (e.g. it is a robot). Conversely, in some implementations the agent comprises a human user of a digital assistant such as a smart speaker, smart display, or other device. Then the information defining the task can be obtained from the digital assistant, and the digital assistant can be used to instruct the user based on the task.

For example, a system implementing the neural network may output to the human user, via the digital assistant, instructions for actions for the user to perform at each of a plurality of time steps. The instructions may for example be generated in the form of natural language (transmitted as sound and/or text on a screen) based on actions chosen by the system. The system chooses the actions such that they contribute to performing a task. A monitoring system (e.g. a video camera system) may be provided for monitoring the action (if any) which the user actually performs at each time step, in case (e.g. due to human error) it is different from the action which the system instructed the user to perform. Using the monitoring system the system can determine whether the task has been completed. The system may identify actions which the user performs incorrectly with more than a certain probability. If so, when the system instructs the user to perform such an identified action, the system may warn the user to be careful. Alternatively or additionally, the system may learn not to instruct the user to perform the identified actions, i.e. ones which the user is likely to perform incorrectly.

More generally, the digital assistant instructing the user may comprise receiving, at the digital assistant, a request from the user for assistance and determining, in response to the request, a series of tasks for the user to perform, e.g. steps or sub-tasks of an overall task. Then for one or more tasks of the series of tasks, e.g. for each task, e.g. until a final task of the series the digital assistant can be used to output to the user an indication of the task, e.g. step or sub-task, to be performed. This may be done using natural language, e.g. on a display and/or using a speech synthesis subsystem of the digital assistant. Visual, e.g. video, and/or audio observations of the user performing the task may be captured, e.g. using the digital assistant. A system as described above may then be used to determine whether the user has successfully achieved the task e.g. step or sub-task, i.e. from the answer as previously described. If there are further tasks to be completed the digital assistant may then, in response, progress to the next task (if any) of the series of tasks, e.g. by outputting an indication of the next task to be performed. In this way the user may be led step-by-step through a series of tasks to perform an overall task. During the training of the neural network, training rewards may be generated e.g. from video data representing examples of the overall task (if corpuses of such data are available) or from a simulation of the overall task.

In a further aspect there is provided a digital assistant device including a system as described above. The digital assistant can also include a user interface to enable a user to request assistance and to output information. In implementations this is a natural language user interface and may comprise a keyboard, voice input-output subsystem, and/or a display. The digital assistant can further include an assistance subsystem configured to determine, in response to the request, a series of tasks for the user to perform. In implementations this may comprise a generative (large) language model, in particular for dialog, e.g. a conversation agent such as Sparrow (Glaese et al. arXiv:2209.14375) or Chinchilla (Hoffmann et al. arXiv:2203.15556). The digital assistant can have an observation capture subsystem to capture visual and/or audio observations of the user performing a task; and an interface for the above-described language model neural network (which may be implemented locally or remotely). The digital assistant can also have an assistance control subsystem configured to assist the user. The assistance control subsystem can be configured to perform the steps described above, for one or more tasks e.g. of a series of tasks, e.g. until a final task of the series. More particularly the assistance control subsystem and output to the user an indication of the task to be performed, capture, using the observation capture subsystem, visual or audio observations of the user performing the task, determine from the above-described answer whether the user has successfully achieved the task. In response the digital assistant can progress to a next task of the series of tasks and/or control the digital assistant, e.g. to stop capturing observations.

As another example, the task can be a genomics task, where the input is a sequence representing a fragment of a DNA sequence or other molecule sequence and the output is either an embedding of the fragment for use in a downstream task, e.g., by making use of an unsupervised learning technique on a data set of DNA sequence fragments, or an output for the downstream task. Examples of downstream tasks include promoter site prediction, methylation analysis, predicting functional effects of non-coding variants, and so on.

In some cases, the machine learning task is a combination of multiple individual machine learning tasks, i.e., the system is configured to perform multiple different individual machine learning tasks, e.g., two or more of the machine learning tasks mentioned above. For example, the system can be configured to perform multiple individual natural language understanding tasks, with the network input including an identifier for the individual natural language understanding task to be performed on the network input.

In some cases, the machine learning task is a multi-modal processing task that requires processing multi-modal data. In general, multi-modal data is a combination of two or more different types of data, e.g., two or more of audio data, image data, text data, or graph data. As one example the multi-modal data may comprise audio-visual data, comprising a combination of pixels of an image or of video and audio data representing values of a digitized audio waveform. As another example the multi-modal data may comprise a combination of i) text data representing text in a natural language and ii) pixels of an image or of video or audio data representing values of an audio waveform. Optionally, but not necessarily, the different types of data may represent the same or overlapping objects using the different modalities (types), and when processing multi-modal data the data may be mapped into a common embedding space.

As a particular example, the task is a multi-modal processing task that requires processing both text and image inputs, so that the neural network includes both a computer vision neural network and a text processing neural network. That is, the target output to be generated by the computer vision neural network for a given image depends on one or more outputs generated by the text processing neural network for one or more corresponding text inputs (and vice versa). Examples of such tasks include open-vocabulary image classification, open-vocabulary object detection, image captioning, text-based image search, image-based retrieval, and so on.

More generally, the multi-modal processing task may correspond to any of the tasks previously described for any of the types of data making up the multi-modal combination. For example, an accuracy of the previously described tasks may be increased when the task is applied to multi-modal data combining the data for which the task has been previously described and another type of data. For example detection or classification of an object or event may be improved when data of multiple different types (modalities) is processed.

In practice, for any of these examples, the task to be performed by the neural network can be defined by (at least a part of) the network input, e.g., that is in the form of a prompt or a request, received by the neural network. In other words, the neural network will be able to perform any of these tasks when an appropriate prompt or request is received.

The neural network can have any appropriate architecture that allows the neural network to receive network inputs of the type required by the machine learning task and to generate network outputs of the form required for the task. Examples of the neural network include fully-connected neural networks, convolutional neural networks, recurrent neural networks, attention-based neural networks, to name just a few.

As a particular example, the neural network can have any of a variety of Transformer-based neural network architectures, e.g., encoder-only Transformer architectures, encoder-decoder Transformer architectures, decoder-only Transformer architectures, diffusion Transformer architectures, other attention-based architectures, and so on.

Examples of such Transformer-based neural network architectures include those described in Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv:1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; Aakanksha Chowdhery, et al. PaLM: Scaling Language Modeling with Pathways, arXiv preprint arXiv:2204.02311; and Rohan Anil, et al. Palm 2 technical report. arXiv preprint arXiv:2305.10403, 2023; Gemini Team. Gemini: a family of highly capable multimodal models. arXiv preprint arXiv:2312.11805 (2023); and Gemini Team. Gemini 1.5: Unlocking multimodal understanding across millions of tokens of context. arXiv preprint arXiv:2403.05530 (2024).

To execute the machine learning workload 104 for training a neural network, the system 100 can receive architecture data defining an architecture of the neural network. The architecture defines the number of layers in the neural network, the operations performed by each of the layers, and the connectivity between the layers in the neural network, i.e., which layers receive inputs from which other layers in the neural network.

The system 100 can also receive training data for training the neural network to perform one or more of the machine learning tasks mentioned above. The training data includes a set of neural network inputs and, optionally, in some cases, for each network input, a respective target output that should be generated by the neural network to perform the particular task. In some cases, a larger set of training data may be randomly partitioned by the system to generate the training data and a validation set for evaluating the performance of the neural network on the tasks.

The system 100 can receive the architecture data and training data in any of a variety of ways. For example, the system 100 can receive the architecture data or the training data as part of or in association with the data specifying the machine learning workload 104. As another example, the system 100 can receive the architecture data or the training data as an upload from the client 102 over the data communication network, e.g., using an application programming interface (API) made available by the system 100. As another example, the system 100 can receive an input from the client 102 specifying which data that is already maintained by the system 100, or another cloud storage system that is accessible by the system, should be used as the architecture data or the training data.

Once the system 100 trains the neural network through the execution of the machine learning workload 104, the system 100 can provide data specifying the trained neural network for use in processing new network inputs. For example, the system 100 can provide, as the output data 154, the trained values of the network parameters to the client 102 for later use in processing inputs using the trained neural network. As another example, the system 100 can output the trained values of the network parameters for storing in a storage device accessible to the system.

Instead of or in addition to outputting the trained neural network data, the system 100 can instantiate an instance of the neural network having the trained values of the network parameters, and receive inputs to be processed and use the trained neural network to process the received inputs to generate outputs and then provide the generated outputs in respect to the received inputs. The system 100 can receive network inputs through an application programming interface (“API”) offered by the system 100. In this way the trained neural network can be made available for use by the system 100 to perform any of a variety of machine learning tasks, e.g., one or more of the tasks described above.

The system 100 is typically hosted within a data center, which can be a distributed, cloud-based computing system having a large number, e.g., hundreds or thousands or millions, of hardware devices. The hardware devices within the system 100 are connected with one another. For example, the hardware devices can be interconnected over an interconnect network, e.g., an Inter-Core Interconnect (ICI) network or another data communication network.

The hardware devices include hardware accelerators, e.g., hardware accelerators 140A-140N, in one or more locations, where N can be any positive integer greater than one. The hardware devices can also include other types of computing devices, including general purpose computing devices, e.g., CPU-based host computers.

Hardware accelerators (or “accelerators” for short) are computing devices having specialized hardware configured to perform specialized computations including, e.g., machine learning computations. Examples of accelerators include graphics processing units (“GPUs”), field-programmable gate arrays (“FGPAs”), and application-specific integrated circuits (“ASICs”), including tensor processing units (“TPUs”).

The system 100 includes a scheduling engine 145 that is connected to the hardware devices including the hardware accelerators 140A-140N and that schedules the computation operations involved in the machine learning workload 104 across the hardware accelerators 140A-140N. That is, the scheduling engine 145 can identify a set of hardware devices to assign for use by the machine learning workload 104.

Once the hardware devices are assigned by the scheduling engine 145, the system 100 can then execute the training steps of the machine learning workload 104 using the assigned hardware devices. In some implementations, the scheduling engine 145 can be implemented on one or more CPU-based host computers.

The scheduling engine 145 can implement any conventional scheduling algorithm for scheduling jobs to the hardware accelerators 140A-140N. Examples of the scheduling algorithm that can be implemented by the scheduling engine 145 include a first come first serve algorithm, a shortest time job first algorithm, a round-robin algorithm, a shortest remaining time first algorithm, a priority scheduling algorithm, to name just a few.

Silent data corruptions (SDCs) impact computational integrity for large-scale workloads. Sources of SDCs include temperature variance, age, among other hardware factors. These errors may not leave any record or trace in system logs. In particular, in reality, there may be no error signal or any other form of notification from the hardware devices themselves, even though the computation outputs may be incorrect (e.g., where some of the values in an output tensor might be corrupted). As a result, SDCs may stay undetected within workloads. Left undetected, these types of corruptions can cause data loss and propagate across the hardware devices and negatively impact the quality of the workloads.

For example, SDC may be caused by defects during manufacturing, electrical fluctuations, and environmental conditions. An SDC occurs when an impacted component inadvertently causes errors in the data it processes. For example, an impacted matrix multiply unit might miscalculate matrix multiplication (e.g., [1 1 1]×[1 0 0]T=2). Errors like the miscalculated matrix multiplications will cause the results of computation operation to become corrupted or tainted or the like, and thus will jeopardize the machine learning workload 104.

For example, for a neural network having multiple layers, a miscalculated result of the computation of the gradients of the outputs of a final layer could cause errors in the computation of gradients of the outputs of any preceding layers. In this example, the parameter values of the neural network may be incorrectly updated due to the miscalculated gradients. When model parallelism is used where each hardware device stores a smaller shard of a larger neural network, this in effect means the miscalculated result that happens at a single hardware device storing the final layer of the neural network is propagated to other hardware devices that store other layers of the neural network.

Within a single training step, a corrupted intermediate value computed by one of the hardware devices may be sent to other hardware devices and hence corrupt the subsequent values computed by those other hardware devices within the same training step. If at any training step a hardware device generates corrupted computation results (e.g., corrupted values of the parameters of the neural network), then this corruption may in fact affect the accuracy of the computation results in all subsequent training steps, and may further cause significant corruption of the neural network and wasted computing and energy resources.

In those scenarios, to successfully perform the machine learning workload 104, the system would have to roll back the neural network to a checkpointed version that has parameter values determined at a preceding time point before the corrupted computation result was generated. However, because of the characteristics of SDCs mentioned above, it is very difficult to determine precisely when the corrupted computation result was generated.

Accordingly, the system 100 illustrated in FIG. 1 includes a silent data corruption (SDC) monitoring engine 150 that uses checksums to detect silent data corruptions that might occur within the hardware devices included in the system 100 during the execution of the machine learning workload 104. In some implementations, the SDC monitoring engine 150 can be implemented on one or more hardware devices, e.g., one or more hardware accelerators, one or more CPU-based host computers, or both.

A “checksum” refers to a sequence of numeric values used to detect changes in data. To generate a checksum of a data item, the system 100 can run a checksum function (e.g., XOR checksum, Fletcher's checksum, cyclical redundancy check (CRC), MD5, SHA-1, SHA-256, or SHA-512) that takes as input the data item and generates as output a sequence of numeric values having a fixed length (e.g., an 8-bit checksum, a 32-bit checksum, or a 64-bit checksum). Small changes in the data item may result in very different checksums, and thus checksums may be compared to determine if two data items are identical to each other.

The system 100 generates checksums that correspond to different time points for each individual hardware device, e.g., each individual hardware accelerator 140A-140N or each individual CPU-based host computer.

At each hardware device, at each time point of a plurality of time points during the execution of the machine learning workload 104, e.g., at each training step in the plurality of training steps, after having performed one or more computation operations since the last time point at which a checksum for the hardware device was generated, the system 100 generates and stores a corresponding checksum for the hardware device and for the time point, e.g., for the training step, based on the local output data that has been generated as a result of the one or more computation operations performed by the hardware device.

For example, as previously mentioned, executing the machine learning workload 104 involves performing a plurality of training steps. At each training step, the system 100 can generate checksums for the intermediate results of the subexpressions (smaller expressions that are evaluated as part of a larger expression) calculated during the training step.

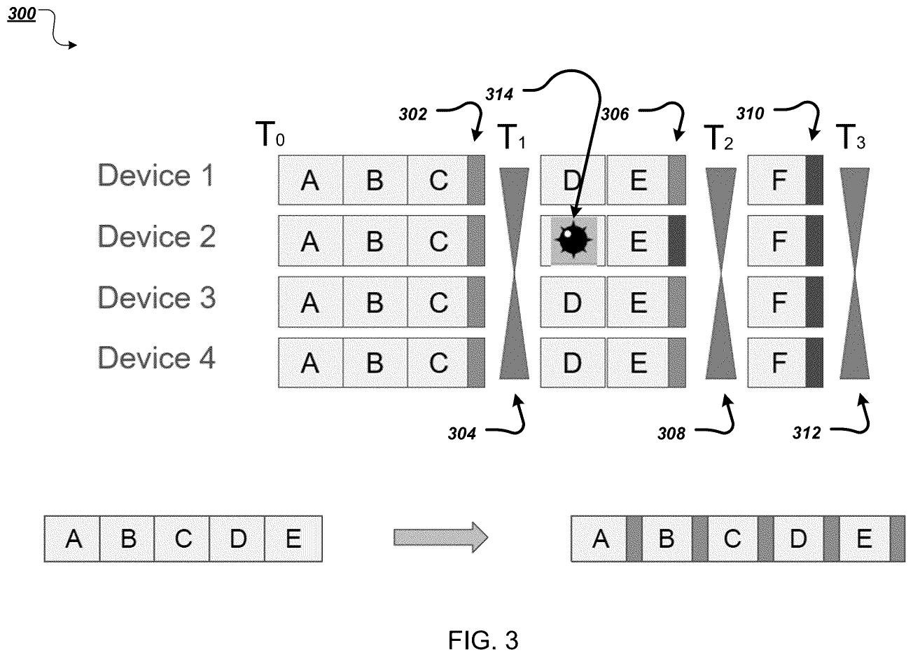

Examples of what the computation operations and the local output data can be are discussed in FIG. 3 below.

As illustrated in FIG. 1, the SDC monitoring engine 150 includes an error detector 152, a comparator 154, and a localizer 156.

The error detector 152 is configured to detect any possible occurrence of errors during the execution of the machine learning workload 104 across the hardware devices including the hardware accelerators 140A-140N. That is, the error detector 152 monitors the execution of the machine learning workload 104 and detects the possible occurrence of errors. In response to detecting a possible error occurrence, the error detector 152 can report the possible error occurrence such that subsequent actions can be taken by the comparator 154 and the localizer 156.

The errors to be detected can be, but need not be, limited to errors that are induced by hardware faults, including silent data corruptions (SDCs). Moreover, the error detector 152 can be configured to detect the possible occurrence of errors in many different ways.

In some implementations, e.g., where the machine learning workload 104 is a training workload for training a neural network, the error detector 152 can detect the possible occurrence of an error by monitoring the data values (or computation results or other numbers) computed during each training step during the training of the neural network.

For example, the error detector 152 can implement a set of heuristics that automatically analyze the data values computed during each training step to facilitate this detection, e.g., based on determining whether those results fall within predetermined, statistical bounds. In response to determining that the data values of a training step are likely incorrect, e.g., because they fall outside of the predetermined, statistical bounds, the error detector 152 generates an indication of the possible occurrence of an error.

There are many different data values that may be monitored during each training step in the training of the neural network. In various implementations, the error detector 152 can monitor the neural network's accuracy at performing a computational task such as a classification task (e.g., as evaluated on the validation set), a loss or cost function within the neural network, a score/reward obtained in a reinforcement learning task, a statistic value (e.g., a norm, a mean, or a standard deviation) of the outputs of each layer of the neural network, and so on.

For example, whenever the accuracy at a training step has dropped by greater than a threshold percentage, e.g., 1%, 2%, or 5%, relative to an immediately preceding training step, then the error detector 152 can generate an indication of the possible occurrence of an error during the training step.

As another example, whenever a norm value of the outputs of a layer (that are computed during a forward pass through the neural network) at a training step has increased by greater than a threshold percentage, e.g., 25%, 50%, or 100%, relative to an immediately preceding training step, then the error detector 152 can generate an indication of the possible occurrence of an error during the training step.

The comparator 154 is configured to compare the checksums at the hardware devices. Specifically, once a possible occurrence of an error during a given training step is reported by the error detector 152, the one or more computation operations that were previously performed during the given training step can be replayed.

That is, each hardware device can re-execute the one or more same computation operations, and the system can generate new checksums for the hardware device based on local output data that is generated as a result of the one or more replayed computation operations.

Then, at each hardware device, the system can use the comparator 154 to compare the new checksum to the checksum that was generated originally. For any hardware device, if the two checksums at the same, given training step differ, there is a possibility that a silent data corruption (SDC) has occurred at the hardware device during the given training step.

The comparator 154 provides data that identifies (i) one or more of the hardware devices, e.g., one or more of the hardware accelerators 140A-140N or one or more of the CPU-based host computers, that have two different checksums and (ii) one or more of the preceding time points at which the mismatches between two checksums occur, to the localizer 156. In other words, the comparator 154 reports to the localizer 156 which ones of the hardware devices have two different checksums and when the mismatches between two checksums occur.

The localizer 156 is configured to locate the faulty hardware device that caused the error based on the date provided by the comparator 154. The localizer 156 can be configured to locate the faulty hardware device in many different ways. For example, the localizer 156 can determine the earliest time point in the one or more preceding time points at which a checksum mismatch exists, and select, as the faulty hardware device that caused the possible occurrence of error, a hardware device that has the mismatch at the earliest time point.

Appropriate remedial actions can then be taken by the system 100 once the SDC monitoring engine 150 has located the faulty hardware device. Examples of remedial actions that can be taken include: pausing the execution of the machine learning training workload; rolling back the neural network to a checkpointed version that has parameter values determined at a preceding time point that precedes the earliest time point at which a checksum mismatch exists; performing the one or more computation operations at the earliest time point that the mismatch occurred using a different hardware device; dropping the local output data generated as a result of the one or more computation operations performed by the faulty hardware device and moving on to the next computation operations; resuming executing the remaining computation operations involved in the machine learning workload 104 using other hardware devices and without using the faulty hardware device; and so on.

Additionally or alternatively the system 100 can generate a notification message about the silent data corruption, and, in some cases, associated data that identifies the faulty hardware device at which the silent data corruption occurred, e.g., a location index of the faulty hardware device, and output the notification message, and, in some cases, the associated data to another system for storage or further analysis, or to the client 102 for presentation.

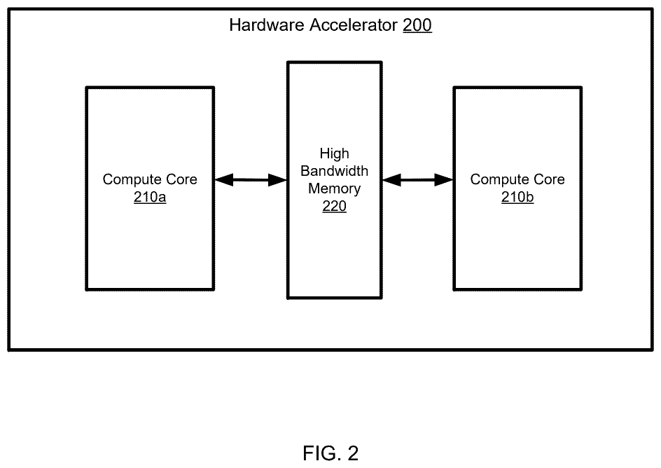

FIG. 2 shows an example architecture of a hardware accelerator 200. The hardware accelerator 200 can correspond to one of the hardware accelerators included in the system 100 of FIG. 1, e.g., hardware accelerator 140A.

As illustrated, the hardware accelerator 200 includes two compute cores (210a, 210b) and a high bandwidth memory 220. The hardware accelerator 200 has a symmetric architecture; it has a compute core 210a on the left hand side, and a compute core 210b on the right hand side. Both compute cores 210a, 210b have access to the same high bandwidth memory 220.

The hardware accelerator 200 stores data in the high bandwidth memory 220, reads the data in and out of the high bandwidth memory, and processes the data at the compute cores (210a, 210b). Each compute core (210a, 210b) itself includes circuitry that is optimized for certain computation operations, e.g., dense linear algebra operations, including matrix multiplication operations, as well as more neural network-specific operations such as convolutions, pooling, etc.

For example, each compute core (210a, 210b) can include one or more of: one or more scalar processing units, one or more vector processing units, or one or more extended vector units, e.g., one or more matrix multiply units, one or more transpose units, or one or more reduction and permutation units.

Errors that are induced by hardware faults, including silent data corruptions (SDCs), might occur within any of these components of the hardware accelerator 200 throughout the execution of the machine learning workload 104. In fact, because these errors are hardware-induced, they might occur at any other hardware devices, including at, e.g., the processing cores of, the CPU-based computing devices included in the system 100.

FIG. 3 is an illustration 300 of operations to mitigate silent data corruption (SDC) when executing a machine learning training workload. The operations can be performed by the system 100 in FIG. 1, which includes the SDC monitoring engine 150.

Because the machine learning training workload performed by the system 100 may be a workload for training a large-scale neural network that has billions or tens of billions of parameters on a large-scale, e.g., Internet-scale, training dataset, that includes billions or tens of billions of network inputs, to ensure the resource efficiency of the SDC monitoring process, the system 100 avoids generating and storing a checksum for each computation operation during the execution of the machine learning training workload. Moreover, the system 100 avoids replaying each and every computation operation.

As illustrated, the system 100 generates checksums that correspond to different time points T₀-T₃ for each hardware device (“Device 1”-“Device 4”). For example, a training step can span T₀-T₃. Between T₀ and T₁, the system 100 performs computation operations A, B, and C on each of Device 1, Device 2, Device 3, and Device 4. The system 100 can perform the computation operations on each hardware device independently of, and in parallel with, other computation operations performed on each other hardware device.

It should be understood that while FIG. 3 illustrates that different hardware devices perform identical computation operations, this is not required for all implementations. That is, in some implementations, different hardware devices can perform different computation operations in parallel.

The computation operations A, B, and C can include any computation operations that are involved in the machine learning training workload for training a neural network. On each of Device 1, Device 2, Device 3, and Device 4, the output(s) generated as a result of the computation operations A, B, and C are referred to as local output data. Specifically, the local output data can include temporary intermediate values of the computation operations for a training step that are not returned to the caller at the end of the training step.

By way of illustration, and not limitation, the computation operation A, B, and C operation can include at least one of: a maximum operation that selects, as the output of the maximum operation, a maximum of the first value and the second value; a summation operation that sums the first value and the second value to generate the output of the summation operation; a multiplication operation that multiplies the first value and the second value to generate the output of the multiplication operation; a median operation that determines, as the output of the median operation, a median of the first value and the second value; a minimum operation that selects, as the output of the minimum operation, a minimum of the first value and the second value; and so on.

For each hardware device, after having performed the computation operations A, B, and C on the hardware device, the system 100 generates a first checksum 302 for T₁ for the hardware device based on local output data generated as a result of the computation operations A, B, and C. The system 100 then stores in the first checksums in a storage device. Specifically, for each hardware device, the first checksum can be generated based on the local output data (that is computed as a result of computation operations A, B, C) that is going to be sent to another hardware device over the interconnect network.

In practice the system 100 can generate the first checksum 302 for each hardware device by applying any known checksum function over the local output data, e.g., over the respective output of the computation operation A, B, or C, or some combination of the respective outputs of the computation operations A, B, or C. Examples of known checksum functions include XOR checksum, Fletcher's checksum, cyclical redundancy check (CRC), MD5, SHA-1, SHA-256, and SHA-512, to name just a few.

At T₁, the system 100 executes a data exchange operation 304 between two or more of Device 1, Device 2, Device 3, and Device 4 to exchange the local output data between two or more of Device 1, Device 2, Device 3, and Device 4, such that at least one of Device 1-Device 4 has the local output data generated as a result of the computation operations A, B, and C performed at another one of Device 1-Device 4. The data exchange operation 304 can include transmitting the local output data from one hardware device to another hardware device over an interconnect network, e.g., an Inter-Core Interconnect (ICI) network, that connects the hardware devices.

Many machine learning training workloads involve distributed, parallel training of a neural network. The distribution can either partition the large amounts of training data into different replications or replicas (e.g., data parallelism), or partition a very large neural network into smaller shards (e.g., model parallelism). The partitioned training data and neural network parameters are put onto different hardware devices to compute concurrently.

The distributed, parallel training of a neural network necessitates data exchange operations between different hardware devices during the execution of the machine learning training workload. For example, under data parallelism, each hardware device ingests a mini-batch of network inputs, computes the local gradients (e.g., as the local output data), and then exchanges all local gradients (e.g., by way of the data exchange operations) throughout the hardware devices to compute a final, globally consistent gradient, with which parameter values of the neural network are updated.

As another example, under model parallelism, each hardware device takes model activation input from its local training data, or from the output of another hardware device that operates on hidden layers before itself. The hardware device then computes the activation output, which can either be a final model output, or serve as the activation input of another hardware device. The gradient is computed on the hardware device that includes the final layer (e.g., as the local output data), and gets sent back to the previous layers (e.g., by way of the data exchange operations) to update the partitioned submodels. Under this approach, intermediate activation outputs, as well as the gradients at the model partitioning boundaries, are sent around the hardware devices.

There are many ways of implementing model parallelism. Some common patterns for sharding of the various components of a neural network across multiple hardware devices include, for example, the Megatron sharding (as described in Shoeybi, Mohammad, et al. “Megatron-lm: Training multi-billion parameter language models using model parallelism.” arXiv preprint arXiv:1909.08053 (2019)), Zero Redundancy Optimizer (ZeRO) sharding (as described in Rajbhandari, Samyam, et al. “Zero: Memory optimizations toward training trillion parameter models.” SC20: International Conference for High Performance Computing, Networking, Storage and Analysis. IEEE, 2020), and fully sharded data parallel (FSDP) sharding (as described in Zhao, Yanli, et al. “Pytorch fsdp: experiences on scaling fully sharded data parallel.” arXiv preprint arXiv:2304.11277 (2023).

In these examples and many other examples, model parallelism involve sharding particular matrices across hardware devices. When the execution of the machine learning workload needs to compute a function of some sharded values, communication across the hardware devices is typically required.

In FIG. 3, the first checksums 302 for Device 1-Device 4 are illustrated as the blocks in the darker color that follow the operations A, B, and C, and the data exchange operation 304 is illustrated as the two triangles pointing toward one another. Note that generating checksums in this manner is different from how checksums are generated in some conventional systems.

As illustrated on the bottom half of FIG. 3, for each hardware device, some conventional systems generate a checksum for the hardware device after each computation operation (regardless of whether the computation operation is followed by a data exchange operation), and thus generating five checksums (each illustrated as a block in the darker color) for five computation operations A, B, C, D, and E.

In contrast, by generating checksums only before the data exchange operations, and not after each computation operation, the system 100 improves the resource efficiency of the SDC monitoring process. By generating a smaller number of checksums, the total compute cost associated with generation of the checksums can be reduced. The savings in compute cost can be significant when the data that is being checksummed is large in size, e.g., when the local output data has many gigabytes in size

Between T₁ and T₂, the system 100 performs computation operations D and E on each of Device 1, Device 2, Device 3, and Device 4. For each hardware device, after having performed the computation operations D and E on the hardware device, the system 100 generates a first checksum 306 for T₂ for the hardware device based on local output data generated as a result of the computation operations D and E. The system 100 then stores in the first checksums in a storage device. At T₂, the system 100 executes a data exchange operation 308 between two or more of Device 1, Device 2, Device 3, and Device 4 to exchange the local output data between two or more of Device 1, Device 2, Device 3, and Device 4, such that at least one of Device 1-Device 4 has the local output data generated as a result of the computation operations D and E performed at another one of Device 1-Device 4.

Between T₂ and T₃, the system 100 performs computation operation F on each of Device 1, Device 2, Device 3, and Device 4. For each hardware device, after having performed the computation operation F on the hardware device, the system 100 generates a first checksum 310 for T₃ for the hardware device based on local output data generated as a result of the computation operation F. The system 100 then stores in the first checksums in a storage device.

At T₃, the system 100 executes a data exchange operation 312 between two or more of Device 1, Device 2, Device 3, and Device 4 to exchange the local output data between two or more of Device 1, Device 2, Device 3, and Device 4, such that at least one of Device 1-Device 4 has the local output data generated as a result of the computation operation F performed at another one of Device 1-Device 4.

As previously mentioned, in some implementations, the system implements a set of heuristics that automatically analyze the data values computed during the training step that spans T₀-T₃. In these implementations, the system may have limited access to the outputs of the computation operations performed during the training step, e.g., the system may only have access to the final output, i.e., the result of the computation operation F.

Hence, the set of heuristics can analyze the output of the computation operation F to determine whether an error has occurred during the training step that spans T₀ and T₃ during the execution of the machine learning training workload. For example, in FIG. 3, the training step can be augmented to return the result of the computation operation F and the checksums 302, 306, and 310.

Suppose, in the example of FIG. 3, the system generates an indication of the possible occurrence of an error after T₃ during the execution of the machine learning training workload after having analyzed the result of the computation operation F using the set of heuristics, the system can replay the one or more computation operations performed at each of the preceding time points T₀-T₃ to generate new checksums 302′, 306′, and 310′.

That is, the system 100 can begin with replaying the computation operations A, B, and C on each of Device 1, Device 2, Device 3, and Device 4. For each hardware device, after having replayed the computation operations A, B, and C on the hardware device, the system 100 can generate a second checksum 302′ for T₁ for the hardware device based on replayed local output data generated as a result of the replayed computation operations A, B, and C.

In some implementations, for each hardware device, after having generated the second checksum 302′, the system 100 immediately, i.e., before moving on to replay the computation operations D, E, and F, compares the first checksum 302 with the second checksum 302′ to generate a comparison result that indicates whether a mismatch between the first checksum and the second checksum exists for the hardware device for T₁.

In some other implementations, for each hardware device, after having generated the second checksum 302′, the system 100 stores the second checksum 302′ for the hardware device in association with a time index that corresponds to the T₁ in a memory from which it can be later retrieved and compared with the first checksum 302, e.g., after having replayed the computation operations D, E, and F.

Next, the system 100 can move on to replay the computation operations D and E on each of Device 1, Device 2, Device 3, and Device 4. For each hardware device, after having replayed the computation operations D and E on the hardware device, the system 100 can generate a second checksum 306′ for T₂ for the hardware device based on replayed local output data generated as a result of the replayed computation operations D and E.

In some implementations, for each hardware device, after having generated the second checksum 306′, the system 100 immediately, i.e., before moving on to replay the computation operation F, compares the first checksum 306 with the second checksum 306′ to generate a comparison result that indicates whether a mismatch between the first checksum and the second checksum exists for the hardware device for T₂.

In some other implementations, for each hardware device, after having generated the second checksum 306′, the system 100 stores the second checksum 306′ for the hardware device in association with a time index that corresponds to the T₂ in the memory from which it can be later retrieved and compared with the second checksum 306, e.g., after having replayed the computation operation F.

Next, the system 100 can move on to replay the computation operation F on each of Device 1, Device 2, Device 3, and Device 4. For each hardware device, after having replayed the computation operation F on the hardware device, the system 100 can generate a second checksum 310′ for T₃ for the hardware device based on replayed local output data generated as a result of the replayed computation operation F.

In some implementations, for each hardware device, each hardware device, after having generated the second checksum 310′, the system 100 immediately compares the first checksum 310 with the second checksum 310′ to generate a comparison result that indicates whether a mismatch between the first checksum and the second checksum exists for the hardware device for T₃.

In some other implementations, for each hardware device, after having generated the second checksum 310′, the system 100 stores the second checksum 310′ for the hardware device in association with a time index that corresponds to the T₃ in the memory. In these implementations, after having replayed the computation operations A-F, the system 100 retrieves, for each hardware device, the second checksums 302′, 306′, and 310′ from the memory and then compares them with the second checksums 302, 306, 310, respectively, to generate the comparison results that indicate whether a mismatch between the first checksum and the second checksum exists for the hardware device for each of time points T₁, T₂, and T₃.

Suppose, in the example of FIG. 3, Device 2 is a faulty hardware device that caused an SDC 314 to occur between T₁ and T₂ during the execution of the machine learning training workload. Using the techniques described in this specification, the system can identify Device 2 as the faulty hardware because the comparison results for T₂ will indicate that a mismatch between the first checksum 306 and the second checksum 306′ exists for Device 2. Moreover, the comparison results for earlier time points, e.g., the comparison results for T₁, will indicate that no other checksum mismatch exists for all hardware devices.

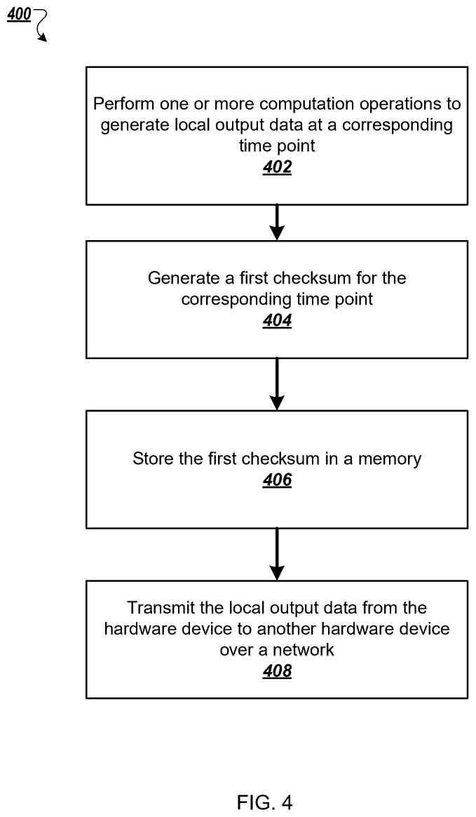

FIG. 4 is a flow diagram of an example process 400 for executing a machine learning training workload. For convenience, the process 400 will be described as being performed by a system of one or more computers located in one or more locations. For example, a system, e.g., the system 100 of FIG. 1, appropriately programmed in accordance with this specification, can perform the process 400.

The process 400 can be performed by the system in response to receiving data that represents the machine learning training workload from a client over a data communication network. That is, the process 400 can be performed as part of the execution of the machine learning training workload by the system.

The system includes a plurality of hardware devices that are connected to each other over a network. Iterations of the process 400 can be repeatedly (i.e., at each of a plurality of time points) performed on each hardware device independently of, and in parallel with, each other hardware device in at least a subset of the plurality of hardware devices. For example, the plurality of hardware devices can include hardware accelerators, CPU-based host computers, or both and possibly other computing devices, and the network can include an interconnect network, a data center network, or both and possibly other data communication networks.

The system performs one or more computation operations on a hardware device to generate local output data at a time point (step 402). The computation operations can include any computation operations that are involved in the machine learning training workload for training a neural network. The local output data can include the respective output of a computation operation, or some combination of the respective outputs of the one or more computation operations, performed by the system on the hardware device.

The system generates a first checksum for the time point based at least on the local output data that has been generated as a result of performing the one or more computation operations on the hardware device (step 404). The first checksum is used for detecting errors induced by potential hardware faults of the corresponding hardware device.

The system stores the first checksum for the hardware device in a storage device (step 406). For example, the system can store the first checksum in a local memory of the hardware device. The storage device can implement any data structure that, for each hardware device in the subset of the plurality of hardware devices, associates the first checksums that correspond to different time points with the hardware device, and that identifies the corresponding time point for each first checksum.

In some implementations, the first checksum is stored in a local storage device, e.g., in the high bandwidth memory 220 of the hardware accelerator 200 depicted in FIG. 2. In some implementations, the first checksum is stored in a remote storage device, e.g., in a memory of a CPU-based host computer. In some implementations, the first checksum is initially stored in a local storage device, which can e.g., be a volatile storage device such as a memory, and subsequently transferred to a remote storage device, which can e.g., be a permanent memory storage such as a hard disk. In these implementations, if desired, the first checksum can be removed from the local storage device.

The system transmits the local output data from the hardware device to each of one or more other hardware devices in the subset of the plurality of hardware devices over the network (step 408), such that at least one of hardware devices in the subset has the local output data generated as a result of the one or more computation operations performed at another one of the hardware devices in the subset.

In effect this enables each hardware device to perform one or more computation operations at a next time point based on remote input data that is generated at a different hardware device, e.g., in addition to local input data that is locally available at the hardware device.

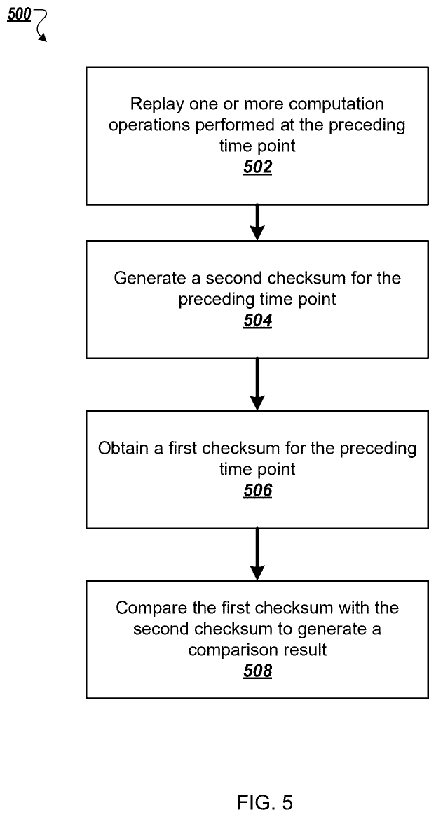

FIG. 5 is a flow diagram of an example process 500 for identifying a faulty hardware device. For convenience, the process 500 will be described as being performed by a system of one or more computers located in one or more locations. For example, a system, e.g., the system 100 of FIG. 1, appropriately programmed in accordance with this specification, can perform the process 500.

The process 500 can be performed whenever the system obtains an indication of a possible occurrence of an error during the executing of the machine learning training workload across the plurality of hardware devices. Iterations of the process 500 can be repeatedly performed for each hardware device in at least the subset of the plurality of hardware devices and for each of one or more preceding time points that precede the possible occurrence of the error.

For example, for each hardware device, the system can perform an iteration of the process 500 for the immediately preceding time point that immediately precedes the possible occurrence of the error, perform another iteration of the process 500 for the further preceding time point that further precedes the immediately preceding time point, and so on, in that reverse temporal order.

Generally, however, the system need not perform the process 500 when no indication of a possible occurrence of an error is obtained. That is, the system will not repeatedly perform an iteration of the process 500 following every iteration of the process 400 discussed above.

The system replays, on a hardware device, one or more computation operations performed on the hardware device at the preceding time point to generate replayed local output data for the preceding time point (step 502). That is, for the preceding time point, the system uses the same hardware device to generate the local output data again. For example, the system can replay the computation operations that have been previously performed during the most recent training step in the plurality of training steps involved in the execution of the machine learning workload.

In some implementations, the system uses different components of the hardware device during the replay than during the execution of the machine learning training workload. That is, the system permutes the hardware devices such that different parts of the computation are computed on different cores, different arithmetic logic units (ALUs), or different matrix multiplier unit (MXUs), for example.

For example, when the hardware device is a hardware accelerator, e.g., the hardware accelerator 200 depicted in FIG. 2, the system can use a different compute core of the hardware accelerator, e.g., compute core 210a, to perform the one or more replayed computation operations than the compute core that was used perform the one or more computation operations during the execution of the machine learning training workload, e.g., compute core 210b.

Doing so can enable the system to more effectively detect deterministic errors caused by hardware faults that occur in hardware devices. Transient errors are those that happen intermittently across repetitions of the same computation operations. In contrast, deterministic errors are those that happen consistently. No matter how many times a computation operation is retried, the same error will always occur.

Advantageously, permuting the hardware devices has minimal computational overhead because the different components of the hardware device, e.g., both compute cores 210a, 210b in FIG. 2, can access the same high bandwidth memory, therefore no data (e.g., model parameter data or model input data) needs to be moved around, e.g., exchanged between the hardware devices, before replaying the computation.

The system generates a second checksum for the preceding time point based at least on the replayed local output data that has been generated as a result of performing the one or more replayed computation operations on the hardware device (step 504). The second checksums are computed using the same checksum function that was used to compute the first checksums.

The system obtains a first checksum for the hardware device for the preceding time point from the storage device (step 506).

The system compares the first checksum with the second checksum to generate a comparison result that indicates whether a mismatch between the first checksum and the second checksum exists for the hardware device for the preceding time point (step 508). If the first checksum and the second checksum are identical to each other, the comparison result indicates that there is no mismatch. Alternatively, if the first checksum and the second checksum differ from each other, the comparison result indicates that there is a mismatch.

By repeatedly performing iterations of the process 500 for each hardware device in at least the subset of the plurality of hardware devices and for each of one or more preceding time points that precede the possible occurrence of the error to generate a comparison result, the system can identify, based on the comparison results, a faulty hardware device among the plurality of hardware devices that caused the possible occurrence of error.

In some implementations, the system can determine the earliest time point in the one or more preceding time points at which a checksum mismatch exists, and select, as the faulty hardware device that caused the possible occurrence of error, a hardware device from the subset of the plurality of hardware devices that has the mismatch at the earliest time point.

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by a plurality of hardware devices, the method comprising:
receiving data representing a machine learning training workload for training a neural network; and
executing the machine learning training workload across the plurality of hardware devices, the executing comprising, at each of at least a subset of the plurality of hardware devices, repeatedly performing training operations comprising:
performing one or more computation operations to generate local output data at a corresponding time point;
generating, based at least on the local output data, a first checksum for the corresponding time point for detecting errors induced by hardware faults;
storing the first checksum in a storage device; and
transmitting the local output data from the hardware device to another hardware device over a network.

2. The method of claim 1, further comprising:
obtaining an indication of an occurrence of an error during the executing of the machine learning workload across the plurality of hardware devices;
in response, for each of at least the subset of the plurality of hardware devices and for each of one or more preceding time points that precede the occurrence of the error:
replaying one or more computation operations performed at the preceding time point to generate replayed local output data for the preceding time point;
generating, based at least on the replayed local output data, a second checksum for the preceding time point;
obtaining a first checksum for the preceding time point from the storage device; and
comparing the first checksum with the second checksum to generate a comparison result that indicates whether a mismatch between the first checksum and the second checksum exists for the hardware device for the preceding time point; and
identifying, based on the comparison result generated for each of at least the subset of the plurality of hardware devices and for each of one or more preceding time points, a faulty hardware device among the plurality of hardware devices that caused the error.

3. The method of claim 2, wherein identifying the faulty hardware device among the plurality of hardware devices that caused the error comprises:
determining an earliest time point in the one or more preceding time points at which a mismatch exists; and
selecting, as the faulty hardware device that caused the error, a hardware device that has the mismatch at the earliest time point.

4. The method of claim 2, wherein the hardware device is a hardware accelerator, and wherein replaying the one or more computation operations performed at the preceding time point comprises:
using a different compute core of the hardware accelerator to perform the one or more computation operations.

5. The method of claim 2, wherein obtaining the indication of the occurrence of the error during the executing of the machine learning training workload comprises:
monitoring a performance of the neural network during the training; and
in response to determining that the performance of the neural network has degraded by greater than a threshold amount, generating the indication of the occurrence of the error.

6. The method of claim 2, further comprising:
resuming executing the machine learning training workload without using the faulty hardware device.

7. The method of claim 1, wherein the storage device comprises a high bandwidth memory local to the hardware accelerator.

8. The method of claim 1, wherein the storage device comprises a memory of a host computer.

9. A system comprising one or more computers and one or more storage devices storing instructions that are operable, when executed by the one or more computers, to cause the one or more computers to perform operations comprising:
receiving data representing a machine learning training workload for training a neural network; and
executing the machine learning training workload across a plurality of hardware devices, the executing comprising, at each of at least a subset of the plurality of hardware devices, repeatedly performing training operations comprising:
performing one or more computation operations to generate local output data at a corresponding time point;
generating, based at least on the local output data, a first checksum for the corresponding time point for detecting errors induced by hardware faults;
storing the first checksum in a storage device; and
transmitting the local output data from the hardware device to another hardware device over a network.

10. The system of claim 9, wherein the operations further comprise:
obtaining an indication of an occurrence of an error during the executing of the machine learning workload across the plurality of hardware devices;
in response, for each of at least the subset of the plurality of hardware devices and for each of one or more preceding time points that precede the occurrence of the error:
replaying one or more computation operations performed at the preceding time point to generate replayed local output data for the preceding time point;
generating, based at least on the replayed local output data, a second checksum for the preceding time point;
obtaining a first checksum for the preceding time point from the storage device; and
comparing the first checksum with the second checksum to generate a comparison result that indicates whether a mismatch between the first checksum and the second checksum exists for the hardware device for the preceding time point; and
identifying, based on the comparison result generated for each of at least the subset of the plurality of hardware devices and for each of one or more preceding time points, a faulty hardware device among the plurality of hardware devices that caused the error.

11. The system of claim 10, wherein identifying the faulty hardware device among the plurality of hardware devices that caused the error comprises:
determining an earliest time point in the one or more preceding time points at which a mismatch exists; and
selecting, as the faulty hardware device that caused the error, a hardware device that has the mismatch at the earliest time point.

12. The system of claim 10, wherein the hardware device is a hardware accelerator, and wherein replaying the one or more computation operations performed at the preceding time point comprises:
using a different compute core of the hardware accelerator to perform the one or more computation operations.

13. The system of claim 10, wherein obtaining the indication of the occurrence of the error during the executing of the machine learning training workload comprises:
monitoring a performance of the neural network during the training; and
in response to determining that the performance of the neural network has degraded by greater than a threshold amount, generating the indication of the occurrence of the error.

14. The system of claim 10, wherein the operations further comprise:
resuming executing the machine learning training workload without using the faulty hardware device.

15. The system of claim 9, wherein the storage device comprises a high bandwidth memory local to the hardware accelerator.

16. The system of claim 9, wherein the storage device comprises a memory of a host computer.

17. A non-transitory computer storage medium encoded with instructions that, when executed by one or more computers, cause the one or more computers to perform operations comprising:
receiving data representing a machine learning training workload for training a neural network; and
executing the machine learning training workload across a plurality of hardware devices, the executing comprising, at each of at least a subset of the plurality of hardware devices, repeatedly performing training operations comprising:
performing one or more computation operations to generate local output data at a corresponding time point;
generating, based at least on the local output data, a first checksum for the corresponding time point for detecting errors induced by hardware faults;
storing the first checksum in a storage device; and
transmitting the local output data from the hardware device to another hardware device over a network.

18. The non-transitory computer storage medium of claim 17, wherein the operations further comprise:
obtaining an indication of an occurrence of an error during the executing of the machine learning workload across the plurality of hardware devices;
in response, for each of at least the subset of the plurality of hardware devices and for each of one or more preceding time points that precede the occurrence of the error:
replaying one or more computation operations performed at the preceding time point to generate replayed local output data for the preceding time point;
generating, based at least on the replayed local output data, a second checksum for the preceding time point;
obtaining a first checksum for the preceding time point from the storage device; and
comparing the first checksum with the second checksum to generate a comparison result that indicates whether a mismatch between the first checksum and the second checksum exists for the hardware device for the preceding time point; and
identifying, based on the comparison result generated for each of at least the subset of the plurality of hardware devices and for each of one or more preceding time points, a faulty hardware device among the plurality of hardware devices that caused the error.

19. The non-transitory computer storage medium of claim 18, wherein identifying the faulty hardware device among the plurality of hardware devices that caused the error comprises:
determining an earliest time point in the one or more preceding time points at which a mismatch exists; and
selecting, as the faulty hardware device that caused the error, a hardware device that has the mismatch at the earliest time point.

20. The non-transitory computer storage medium of claim 18, wherein the hardware device is a hardware accelerator, and wherein replaying the one or more computation operations performed at the preceding time point comprises:
using a different compute core of the hardware accelerator to perform the one or more computation operations.
